(19) United States
(12) Patent Application Publication
(10) Pub. No.: US 2010/0023152 A1
(43) Pub. Date: Jan. 28, 2010

(54) Wireless manufacturing line control

(75) Inventor: Richard Lysaght, Hicksville, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: C.E. Electronics

(21) Appl. No.: 12/220,288

(22) Filed: Jul. 23, 2008

(51) Int. Cl. G06F 19/00

(52) U.S. Cl. 700/108; 700/95

(57) ABSTRACT

This device is a wireless tool monitor assembly line interface. The current embodiment of this new tool monitor has the ability to communicate with multiple different tool types. Pneumatic, electric, click based torque tools, and strain gauge torque transducers can all be outfitted with a radio. Once outfitted with a radio, and programmed to communicate with a common protocol, all of these devices can communicate with the tool monitor. The device is especially useful with a plurality of wireless qualifiers for monitoring and controlling a plurality of wireless tools wherein the wireless qualifiers are configured to send wireless signals to the wireless interface: a plurality of wireless tools configured to send wireless signals to the wireless qualifiers; and a wireless self-contained internal power supply located in the transducer housing.

### FIELD OF THE INVENTION

This invention relates to a wireless manufacturing line control. The line control is configured to communicate with multiple qualifiers and multiple different tool types.

### BACKGROUND OF THE INVENTION

U.S. Pat. Nos. 6,055,484 and 5,937,370 represent a recent, significant development in the field of tool monitoring and assembly qualifying. The programmed microprocessor is configured to identify a portion of the signal representative of the analog signal corresponding to a completed cycle. The configuration also allows for identification of an incomplete cycle and a multiple counting of a completed cycle (double-hit). The qualifiers and disclosures of U.S. Pat. Nos. 6,055,484 and 5,937,370 are herein incorporated by reference. U.S. Pat. No. 6,349,266 represents another generation of qualifiers using a remote control qualifier, which herein is incorporated by reference. This RF system includes a mechanical tool having a transmitter for sending electrical signals to a receiver; and a remote qualifier having a receiver for receiving the electrical signals from the transmitter of the mechanical tool.

Past embodiments of pneumatic qualifier technologies have proved challenging when implemented in some production facilities. Many manufacturers would prefer to “cut the cord” and go wireless so that no additional cables have to be tethered to the pneumatic hoses that are used in the assembly process.

The challenges of creating a wireless pneumatic tool lie in the current consumption of the microprocessor, pneumatic transducer, and radio module. In order to operate from a battery and maximize the life of that battery, low power sleep states need to be employed when the tool is at rest and fastenings are not taking place.

Assembly plants are filled with tools, tool monitors, and tool controllers. A typical tool monitor will supervise the tool's fastening process and then report back to both the operator and the system if the fastening was good or bad (OK/NOK). In most cases, these tools have bulky cables leading away from the tool and back to the monitor. These cables are necessary for sending signals between the tool and the monitor.

In many cases it would be advantageous to eliminate the signal cables and replace them with radio transceivers.

### BRIEF SUMMARY OF THE INVENTION

The current embodiment of this new tool monitor has the ability to communicate with multiple different tool types. Pneumatic, electric, click based torque tools, and strain gauge torque transducers can all be outfitted with a radio. Once outfitted with a radio, and programmed to communicate with a common protocol, all of these devices can communicate with the tool monitor.

The monitor has multiple parameter sets and is programmed to utilize one parameter set at a time. Each parameter holds information about the tool that will send results while in that parameter set. The tool information includes but is not limited to tool type, radio address and radio channel. So, while in a given parameter set, the monitor can be programmed to only accept reports from any one given tool.

As different parameter sets are selected either automatically through sequencing or manually through electrical stimulus, an entirely different tool may be selected. Or different settings within the same tool may be selected. This behavior allows the monitor to monitor multiple different processes on the same assembly line. This invention eliminates the signal cables and replaces them with radio transceivers. The elimination of the signal cable frees the tool from being tethered to the monitor. Signal cables are also an item that can need regular maintenance. The pushing, pulling, twisting, etc. of these cables causes them to wear out. Radio transceivers can reduce or eliminate this costly maintenance.

The concept behind this new product is to create a full blown monitor (qualifier) that is packaged with the pneumatic transducer. A microprocessor packaged with the transducer can monitor the entire fastening process, determine if the fastening was good or bad, and then transmit that result back to an interface that can communicate with the manufacturing line controls and also provide a HMI (human-machine interface).

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a block diagram for a wireless qualifier using a strain-gauge pressure transducer.

FIG. 2 is a block diagram for a wireless qualifier using a highly integrated pressure transducer.

FIG. 3 shows an enclosure assembly that allows for manufacturing line control that allow the qualifier of this invention to communicate with multiple different tool types.

### DETAILED DESCRIPTION OF THE INVENTION

One embodiment for the use of multiple tools is in a “shoot and click” environment where fasteners are ran in with pneumatic tools and then confirmed with a click wrench. In this scenario a wireless pneumatic transducer can monitor the air tool and report each fastening back to the monitor. Once a batch is completed, a new parameter is selected and a click wrench is used to confirm that each fastener has been torqued. The click wrench can also be outfitted with a wireless transceiver that reports each click back to the monitor. In most assembly processes, a torque audit is performed to ensure that each tool is set up to deliver the appropriate torque. Yet another parameter may be set up in the monitor to communicate with a transducerized torque tool equipped with a radio. An auditor can then check fastener's torque values without having to carry an extra torque monitor. The auditor can use the production monitor in an “audit” mode or audit parameter.

This qualifier is a counting apparatus that monitors either the pressure of an air tool, the current of an electrical tool or the torque of a mechanical wrench to determine if the tool has shutoff at a target torque. An air pressure tool will be used to illustrate the invention.

The qualifier also determines if some unknown means shuts off the tool. While many versions may exist, I will discuss four different versions of the qualifier. They are:

Version A—used on single ported air tools;

Version B—used for dual port air tools;

Version C—used with electrical tools; and

Version D—used with mechanical “click” (torque) wrenches.

The air tools are connected to a pressure transducer. The electric tools are connected to current transducers. The mechanical tools are connected to torque switches. See U.S. Pat. No. 5,937,370 for illustrations of these.

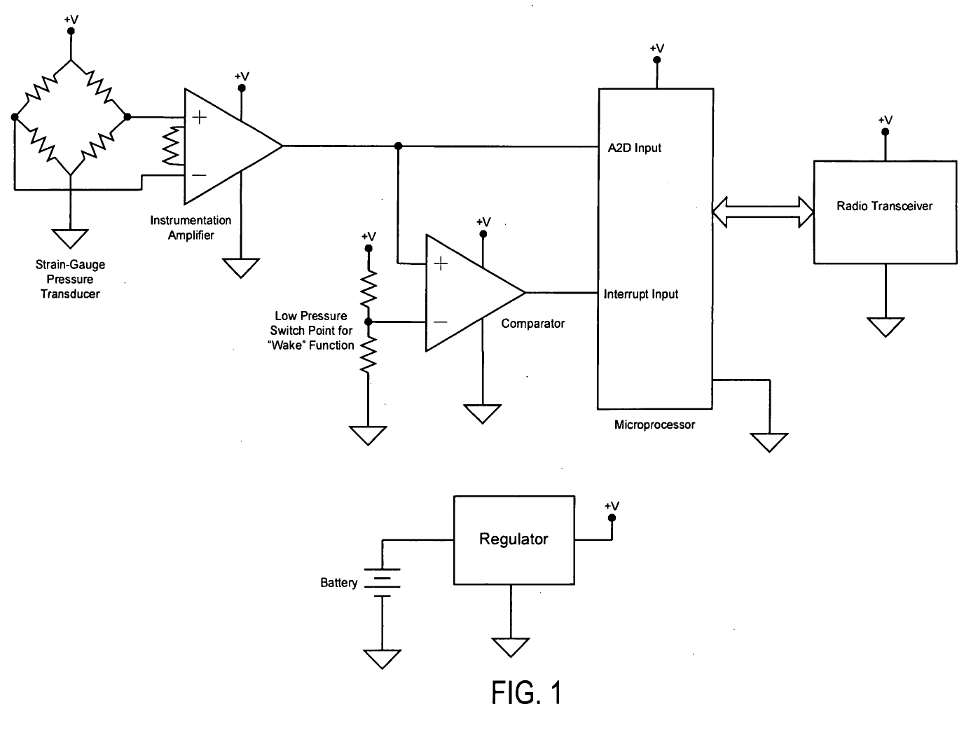

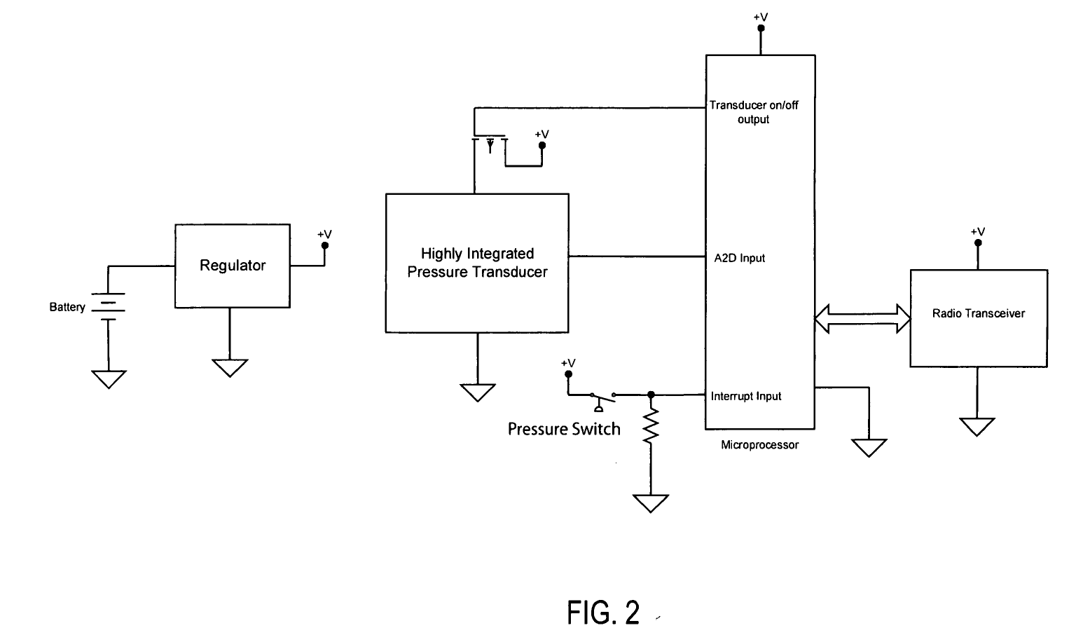

Version A, single ported air tools will illustrate the system. FIG. 1 illustrates a strain-gauge pressure transducer and FIG. 2 illustrates a highly integrated pressure transducer.

In the illustrated embodiment, the wireless, manufacturing line control is configured to communicate with a wireless qualifier for monitoring and controlling a wireless compressed air driven tool. The qualifier comprises a wireless transducer for measuring air pressure within a pneumatic tool and converting of the air pressure into an electrical signal representative of the air pressure; a wireless programmed microprocessor configured to identify a portion of the signal representative of the air pressure; and a wireless self-contained internal power supply located in the air driven tool.

The system further comprises a wireless transceiver for receiving and transmitting remote signals between the transducer, the microprocessor and the power supply; wherein the microprocessor is configured to control the pressure of air in response to the signal received from the pressure transducer; wherein the microprocessor is configured to wake up and come out if its low-current sleep state when a conditioned signal from the transducer is greater than a reference signal; and wherein the microprocessor is configured to monitor the pressure of the pneumatic tool when the microprocessor is awake.

FIG. 1 shows a strain gauge pressure transducer employed to monitor the pressure within the tool. If the resistance in the strain gauge is reasonably high, the current consumption of this device will be relatively low and therefore can be left running all the time. The output of strain gauge transducers is a relatively low level signal so a low current instrumentation amplifier is used to condition the signal from the transducer so that the signal is large enough to be useful to the analog to digital converter on the microprocessor.

That conditioned signal is also sent through another op-amp that is used as a comparator. This conditioned signal is sent to the positive terminal on the comparator. A voltage reference is sent into the negative terminal on the comparator. This reference voltage represents a low level pressure. Once the conditioned signal from the transducer is greater than the reference signal, the output of the comparator swings from low to high. This low to high transition is used to wake up the microprocessor and bring it out of its low-current sleep state.

While the processor is awake, it monitors the pressure inside the pneumatic tool. At the end of a fastening, the microprocessor determines if the analog signature created by the pneumatic tool is such that the fastening can be deemed good or bad. That result is radioed to the line control Once the line control receives the information from the battery powered module, it sends a response or handshake letting the device know that it can go back into its sleep state. Upon reception of the handshake, the microprocessor puts all necessary devices (radio, etc. . . . ) into a low current draw mode and then suspends its own processing so that it too can be placed in a low current suspended mode.

A new fastening process will be sensed by the transducer and the comparator will once again wake the microprocessor starting the whole cycle over.

FIG. 2 shows a second embodiment of this circuit. The embodiment is very similar in function to the embodiment shown in FIG. 1. However a more evolved pressure transducer is used. These types of integrated transducers have pre-conditioned outputs so that they can be attached directly to analog to digital converters on microprocessors. But, they also use more current.

Since these transducers draw more current, they too need to be turned on and off between fastening cycles. So, a pressure switch is employed. When a pneumatic tool begins a fastening process, the pressure switch is activated and this activity is sensed by the microprocessor. The microprocessor comes out of its low current sleep state and turns on all necessary devices including the analog pressure transducer and the radio.

At the end of the fastening process, the result is radioed to the line control. Upon reception of the line controls response, the microprocessor turns off current hungry devices like the transducer and the radio and then goes to sleep to save current (and ultimately battery life).

A new fastening activates the pressure switch and the cycle starts over.

In both embodiments when the circuit is up and running, the whole circuit will draw over 100 milliamps. When all devices are in sleep state, the circuit can radically cut its current consumption down to 1 or 2 milliamps or even into the microampere range. So, the benefits to battery life are obvious.

The transducer in this application senses pressure. That pressure is reported to a microprocessor and the microprocessor makes decisions based on the pressure “signature”. Once a fastening is complete, the microprocessor sends a report about the fastening process through an RF transceiver module wirelessly back to a “receiver” box that is mounted on the assembly line. After the report is transmitted and a response is received, the microprocessor “goes to sleep” or enters a low current state where it waits for the next pressure event to occur. The sleep state is instituted to stretch out battery life.

The regulator attached to the battery in the figures is necessary because the voltage out of the battery is going to vary. As the battery is used, that voltage is going to decline. The voltage will then be raised back up after the battery is recharged or replaced.

The microprocessor wants to be run at a very specific voltage. Also, A2D conversions need to be based (referenced) off a fixed voltage. The regulator takes a voltage from 0.8 VDC to 4.5 VDC and turns it into 3.3 VDC. This provides a consistent voltage to the microprocessor.

The tools used with this invention are conventional and well known in the art. The labeled rectangular box of the Figures adequately represent them. U.S. Pat. No. 5,377,578 illustrates air tools and related components which one could use with the monitor of the invention. U.S. Pat. Nos. 5,567,886 and 5,592,396 disclose other fluid driven tools using compressed air, electronics or mechanical advantage which depend upon torque to perform their operation. The qualifier of this invention is used with no modification to the tool. Measuring the parameters discussed provides the necessary input to the monitor/controller qualifier claimed.

In the preferred embodiment the wireless transceiver is a radio transceiver; the pressure transducer is a strain-gauge pressure transducer or a highly integrated pressure transducer. The self-contained internal power supply is a battery which is connected to a wireless regulator for receiving signals. The system further comprises a low current instrumentation amplifier to condition the signal from the transducer so that the signal is large enough to be useful to an analog to digital converter on the microprocessor.

The system further comprises a comparator connected between the amplifier and the microprocessor wherein the conditioned signal from the comparator is sent to the microprocessor. The microprocessor then determines if the analog signature created by the pneumatic tool is such that the fastening can be deemed good or bad. The microprocessor then radios the fastening result to a line control. The regulator then puts the power supply into its sleep state upon receiving the signal from the line control. Finally the microprocessor places all the devices into a low current draw mode upon receiving the signal from line control; and further is configured to suspend its own processing and place itself in a low current suspended mode.

The microprocessor is configured to start the whole cycle over when a new fastening process is sensed by the transducer and the comparator.

The integrated transducers further comprise pre-conditioned outputs attached directly to analog to digital converters on the microprocessors. The integrated transducer further comprises a pressure switch, wherein the integrated transducer is configured to activate the pressure switch when the pneumatic tool begins a fastening process. Next, the microprocessor is configured to sense the activity of the pressure switch. The microprocessor is configured to come out of its low current sleep state and turn on all necessary devices including the analog pressure transducer and the radio when sensing the activity of the pressure switch.

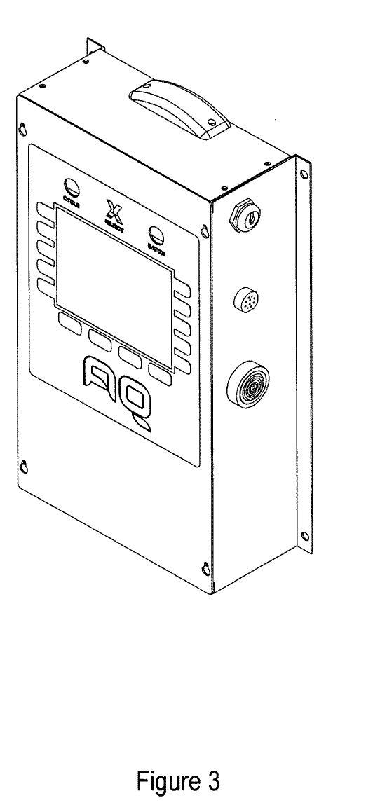

FIG. 3 shows an enclosure assembly that allows for manufacturing line controls that allow the line control of this invention to communicate with multiple qualifiers and multiple different tool types. This embodiment is a wireless tool monitor assembly line interface.

Assembly plants are filled with tools, tool monitors, and tool controllers. A typical tool monitor will supervise the tool's fastening process and then report back to both the operator and the system if the fastening was good or bad (OK/NOK). In most cases, these tools have bulky cables leading away from the tool and back to the monitor. These cables are necessary for sending signals between the tool and the monitor.

In many cases it would be advantageous to eliminate the signal cables and replace them with radio transceivers. The elimination of the signal cables and replace them with radio transceivers. The elimination of the signal cable frees the tool from being tethered to the monitor. Signal cables are also an item that can need regular maintenance. The pushing, pulling, twisting, etc. of these cables causes them to wear out. Radio transceivers can reduce or eliminate this costly maintenance.

The current embodiment of this new tool monitor has the ability to communicate with multiple different tool types. Pneumatic, electric, click based torque tools, and strain gauge torque transducers can all be outfitted with a radio. Once outfitted with a radio, and programmed to communicate with a common protocol, all of these devices can communicate with the tool monitor.

The monitor has multiple parameter sets and is programmed to utilize one parameter set at a time. Each parameter holds information about the tool that will send results while in that parameter set. The tool information includes but is not limited to tool type, radio address and radio channel. So, while in a given parameter set, the monitor can be programmed to only accept reports from any one given tool.

As different parameter sets are selected either automatically through sequencing or manually through electrical stimulus, an entirely different tool may be selected. Or different settings within the same tool may be selected. This behavior allows the monitor to monitor multiple different processes on the same assembly line.

One embodiment for the use of multiple tools is in a “shoot and click” environment where fasteners are ran in with pneumatic tools and then confirmed with a click wrench. In this scenario a wireless pneumatic transducer can monitor the air tool and report each fastening back to the monitor. Once a batch is completed, a new parameter is selected and a click wrench is used to confirm that each fastener has been torqued. The click wrench can also be outfitted with a wireless transceiver that reports each click back to the monitor. In most assembly processes, a torque audit is performed to ensure that each tool is set up to deliver the appropriate torque. Yet another parameter may be set up in the monitor to communicate with a transducerized torque tool equipped with a radio. An auditor can then check fastener's torque values without having to carry an extra torque monitor. The auditor can use the production monitor in an “audit” mode or audit parameter.

Another embodiment is to use multiple parameter sets with one wireless tool. If the desired torque or batch count needs to vary between assembled devices, multiple parameter sets could be employed to account for this variation.

The monitor is also intended to be equipped with network communication. This monitor has the ability to communicate statuses to a network for each fastener that has been completed. The network can also request various actions from the monitor. For example, the network might request an old torque value of a previous fastening. The network might re-program a high or low torque setting or a batch count to accommodate a new product or a change to an existing product. The network might also change parameters so that different tools are used for different parts of an assembly process.

In addition to these embodiments, persons skilled in the art can see that numerous modifications and changes may be made to the above invention without departing from the intended spirit and scope thereof.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. A wireless, manufacturing line control comprising:
a wireless tool monitor assembly line interface configured to identify signals from a plurality of wireless qualifiers for monitoring and controlling a plurality of wireless tools;
a plurality of wireless qualifiers for monitoring and controlling a plurality of wireless tools wherein the wireless qualifiers are configured to send wireless signals to the wireless interface;
a plurality of wireless tools configured to send wireless signals to the wireless qualifiers; and
a self-contained internal power supply located in the wireless tools.

2. A wireless line control according to claim 1 wherein the plurality of wireless tools further comprises a plurality of wireless, compressed air driven tools, wireless, electrically driven tools and wireless mechanical torque wrenches.

3. A wireless line control according to claim 1 wherein the wireless line control further comprises a wireless transceiver.

4. A wireless line control according to claim 1 wherein the wireless qualifiers further comprises a wireless transceiver.

5. A wireless line control according to claim 1 wherein the wireless line control is configured to supervise the plurality of wireless tools and configured to confirm if a fastening was good or bad (OK/NOK).

6. A wireless line control according to claim 1 wherein the wireless control further comprises multiple parameter sets and is programmed to utilize one parameter set at a time.

7. A wireless line control according to claim 6 wherein the multiple parameter sets wherein each of the parameter sets holds information about the tools and the liner control is configured to send results while in that parameter set.

8. A wireless line control according to claim 6 wherein the wireless line control is programmed to only accept signals from any one of the tools while in a given parameter set.

9. A wireless line control according to claim 1 wherein the wireless line control is configured for the use of multiple tools in a “shoot and click” environment wherein fastener are run with pneumatic tools and then confirmed with a click wrench.

10. A wireless line control according to claim 1 wherein the wireless line control is configured to carry out a torque audit to ensure that each of the tools is set up to deliver the appropriate torque.

11. A wireless line control according to claim 1 wherein the wireless line control is configured to communicate with a transducerized torque tool equipped with a radio and further configured to check a fastener's torque values without having to utilize an extra torque monitor.

12. A wireless line control according to claim 1 wherein the self-contained internal power supply of the wireless tool is a battery.

13. A wireless line control according to claim 1 wherein the plurality of wireless qualifiers further comprises a wireless qualilfier for monitoring and controlling a wireless, compressed air driven tool comprising:
a pressure transducer for measuring air pressure within a pneumatic tool and converting of the air pressure; into an electrical signal representative of the air pressure;
a programmed microprocessor configured to identify a portion of the signal representative of the air pressure;
a programmed microprocessor configured to identify a portion of the signal representative of the air pressure;
a self-contained internal power supply located in the wireless transducer;
a wireless transceiver for receiving and transmitting remote signals between the transducer, the microprocessor and the power supply;
wherein the microprocessor is configured to monitor the pressure of air in response the signal received from the pressure transducer;
wherein the microprocessor is configured to wake up and come out of its low-current sleep state when a conditioned signal from the transducer is greater than a reference signal; and
wherein the microprocessor is configured to monitor the pressure of the pneumatic tool when the microprocessor is awake.

14. A wireless line control according to claim 1 the plurality of wireless qualifiers further comprises a wireless qualifier for monitoring and controlling a wireless, electrically driven tool having current flow through the tool comprising:
a current transducer for measuring and converting the currents into electrical signals representative the measured currents;
a programmed microprocessor configured to identify a portion of the signal representative of the electrical signals;
a self-contained internal power supply located in the electrically driven tool;
a wireless transceiver for receiving and transmitting remote signals between the transducer, the microprocessor and the power supply;
wherein the microprocessor is configured to control the electrical current response the signal received from the transducer;
wherein the microprocessor is configured to wake up and come out of its low-current sleep state when a conditioned signal from the transducer is greater than a reference signal; and
wherein the microprocessor is configured to monitor the electrical current of the tools when the microprocessor is awake.

15. A wireless line control according to claim 1 the plurality of wireless qualifiers further comprises a:
a wireless qualifier for monitoring and controlling a wireless, a mechanical torque wrench with torque switch comprising:
a means for electrically stimulating the switch wherein the torque switch can provide an electrical signal upon reaching target torque;
a programmed microprocessor configured to identify a portion of the signal representative of the mechanical torque;
a self-contained internal power supply located in the tool;
a wireless transceiver for receiving and transmitting remote signals between the transducer, the microprocessor and the power supply;
wherein the microprocessor is configured to monitor the torque in response the signal received from the torque switch;
wherein the microprocessor is configured to wake up and come out of its low-current sleep state when a conditioned signal from the transducer is greater than a reference signal; and
wherein the microprocessor is configured to monitor the torque of the tool when the microprocessor is awake.
